(19) United States
(12) Patent Application Publication
(10) Pub. No.: US 2015/0228106 A1
(43) Pub. Date: Aug. 13, 2015

(54) LOW LATENCY VIDEO TEXTURE MAPPING VIA TIGHT INTEGRATION OF CODEC ENGINE WITH 3D GRAPHICS ENGINE

(71) Applicant: VIXS SYSTEMS INC., Toronto (CA)

(72) Inventor: Indra Laksono, Richmond Hill (CA)

(73) Assignee: VIXS SYSTEMS INC., Toronto (CA)

(21) Appl. No.: 14/179,618

(22) Filed: Feb. 13, 2014

(51) Int. Cl. G06T 15/04; G06T 1/60

(52) U.S. Cl. CPC G06T 15/04; G06T 1/60

(57) ABSTRACT

A graphics system includes a codec engine to decode video data to generate a sequence of decoded blocks of a video image and a graphics engine to render a geometric surface in a display picture by rendering polygons of the geometric surface using each decoded block as a texture map for a corresponding subset of the polygons concurrent with the codec engine generating the next decoded block. The graphics engine can render the geometric surface by mapping the polygons to a grid of regions corresponding to the decoded blocks, and as each decoded block is generated, the graphics engine identifies a corresponding subset of the polygons that intersect a grid region corresponding to the decoded block based on the mapping, and for each polygon of the subset, render in the display picture that portion of the polygon that intersects the region using the decoded block as a texture map.

### FIELD OF THE DISCLOSURE

The present disclosure generally relates to three-dimensional (3D) graphics and more particularly to texture mapping for 3D graphics.

### BACKGROUND

Three dimensional (3D) graphics systems increasingly are incorporating the use of streamed video as part of the display imagery in conjunction with rendered graphics. Typically, the video is projected onto geometric surfaces of a three-dimensional object, such as a globe, box, column, and the like. The ability to map real-time video onto geometric surfaces enables new display configurations for graphical user interfaces and complements advanced display technologies, such as flexible screen displays or even holographic displays. Typically, such real-time video is received in the form of an encoded video stream, and in conventional graphics systems the codec engine that decodes the encoded video stream and the 3D graphics engine that renders the resulting display pictures typically are separate engines that operate relatively independently of each other. In particular, the codec engine and the 3D graphics engine typically interact using off-chip memory, whereby the codec engine decodes an entire video image and stores the entire decoded video image in the off-chip memory, and the 3D graphics engine is then signaled to perform a texture mapping of the decoded video image onto a geometric surface only once the entire picture is decoded and stored in memory. As such, conventional approaches to video-based texture mapping introduce considerable latency between when a decoded video image has been decoded and thus would be ready for presentation and when the 3D graphics engine completes mapping the video image to the geometric surface. Moreover, this approach consumes considerable bandwidth as the 3D graphics engine is required to frequently access the decoded video image from the off-chip memory as the texture mapping process progresses. In many cases, this memory comprises system memory or other memory implemented for other uses in addition to texture mapping, and thus the memory bandwidth consumed by conventional video texture mapping processes can negatively impact overall system performance.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a 3D graphics system utilizing block-by-block video texture mapping in accordance with at least one embodiment of the present disclosure.

FIG. 2 is a flow diagram illustrating a method for block-by-block video texture mapping in the 3D graphics system of FIG. 1 in accordance with at least one embodiment of the present disclosure.

FIG. 3 is a diagram illustrating an example application of the method of FIG. 2 in accordance with at least one embodiment of the present disclosure.

### DETAILED DESCRIPTION

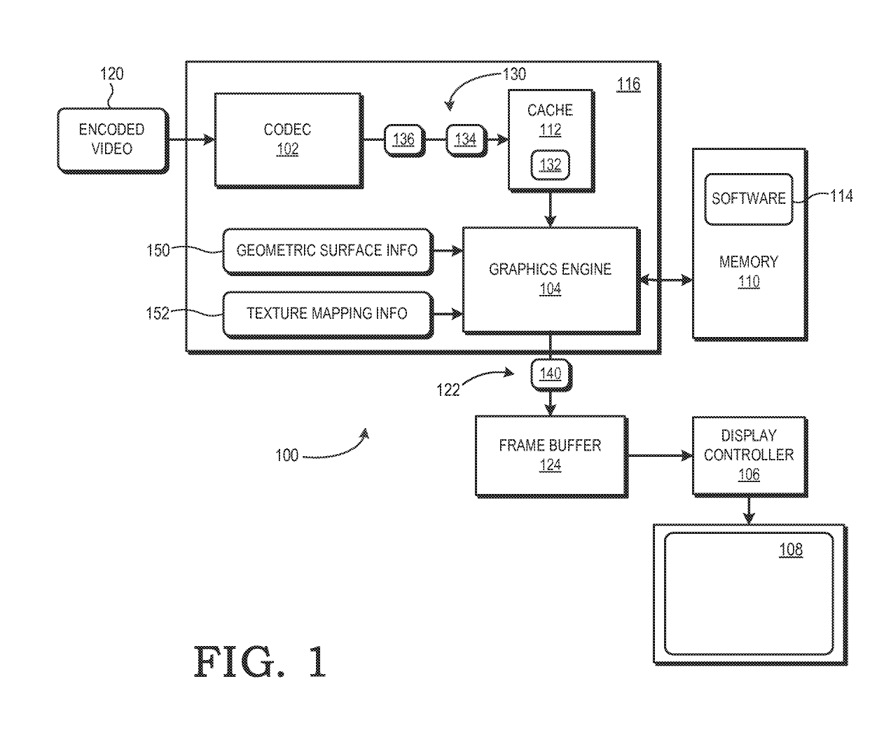

FIGS. 1-3 illustrate example techniques for mapping real-time video or other video onto geometric surfaces of 3D objects in display pictures based on tight integration between a codec engine that decodes encoded video data to generate the video image to be mapped to a geometric surface in a display picture and the 3D graphics engine that renders the display picture in part by performing the texture mapping of the video image to the geometric surface. In at least one embodiment, the rendering of a display picture is performed concurrently with the decoding of a video image mapped into the display picture. That is, in contrast to conventional video texture mapping systems that require decoding of the video image to be completed before texture mapping using the video image can begin, the techniques described herein enable the use of each decoded block of the video image to be used, in effect, as a separate texture for corresponding polygons of the geometric surface as the decoded block is generated by the codec engine. This technique therefore is referred to herein as “block-by-block video texture mapping” for ease of reference.

In at least one embodiment, the block-by-block video texture mapping process includes organizing or otherwise representing the video image as a grid of regions, each region corresponding to a respective decoded block of the video image that will be generated during the decoding process. The block can comprise tiles of pixels, rows of tiles, columns of tiles, and the like. For example, a block can comprise a macroblock of 16×16 pixels per the Motion Pictures Experts Group (MPEG) family of standards, a row or partial row of macroblocks or other grouping of contiguous macroblocks in the video image. A wireframe or polygon mesh representation of the geometric surface identifies the polygons present in the geometric surface, and the graphics engine maps these polygons to the grid of regions for the video image in accordance with a specified mapping or wrapping of the video image to the geometric surface. Concurrently, a codec engine initiates decoding of the video image, producing a sequence or stream of decoded blocks of the video image as the decoding process progresses. As each decoded block is generated, the graphics engine identifies the subset of polygons of the geometric surface that intersect the decoded block, and the 3D graphics engine then at least partially renders the subset of the polygons in the display picture using the decoded block as a texture map during this rendering process.

Concurrently, the codec engine is decoding the next block of the video image, and when the next decoded block is thus generated, the process of identifying a corresponding subset of polygons of the geometric surface that intersect this decoded block and then at least partially rendering this subset of polygons using this decoded block as a texture map is repeated for this next decoded block, and so on. In this manner, the display picture is rendered as the video image is decoded, rather than waiting for the decoding of the video image to complete before beginning the rendering process. As such, the latency between decoding of the video image and completion of the display picture is reduced, thereby facilitating the effective mapping of real-time video into a rendered graphics.

Moreover, under this approach, each decoded block can be temporarily cached in a cache co-located on-chip with the graphics engine, and the graphics engine can access the decoded block from the cache as the texture for the corresponding subset of polygons, thereby allowing the graphics engine to render the display picture without requiring the use of, or access to, an external or off-chip memory to store video image data as texture data, and thus the graphics engine can perform video texture mapping without the frequent memory accesses and resulting memory bandwidth consumption found in conventional video texture mapping systems.

FIG. 1 illustrates an example 3D graphics system 100 implementing block-by-block video texture mapping in accordance with at least one embodiment of the present disclosure. In the depicted example, the 3D graphics system 100 includes an encoder/decoder (codec) engine 102, a graphics engine 104, a display controller 106, a display 108, a memory 110, and a cache 112. The codec engine 102 and graphics engine 104 each may be implemented entirely in hard-coded logic (that is, hardware), as a combination of software 114 stored in a non-transitory computer readable storage medium (e.g., the memory 110) and one or more processors to access and execute the software, or as combination of hard-coded logic and software-executed functionality. To illustrate, in one embodiment, the 3D graphics system 100 implements a system on a chip (SOC) or other integrated circuit (IC) package 116 whereby portions of the codec engine 102 and graphics engine 104 are implemented as hardware logic, and other portions are implemented via firmware (one embodiment of the software 114) stored at the IC package 116 and executed by one or more processors of the IC package 116. Such processors can include a central processing unit (CPU), a graphics processing unit (GPU), a microcontroller, a digital signal processor, a field programmable gate array, programmable logic device, state machine, logic circuitry, analog circuitry, digital circuitry, or any device that manipulates signals (analog and/or digital) based on operational instructions that are stored in the memory 110 or other non-transitory computer readable storage medium. To illustrate, the codec engine 102 may be implemented as, for example, a CPU executing video decoding software, while the graphics engine 104 may be implemented as, for example, a GPU executing graphics software.

The non-transitory computer readable storage medium storing such software can include, for example, a hard disk drive or other disk drive, read-only memory, random access memory, volatile memory, non-volatile memory, static memory, dynamic memory, flash memory, cache memory, and/or any device that stores digital information. Note that when the processing module implements one or more of its functions via a state machine, analog circuitry, digital circuitry, and/or logic circuitry, the memory storing the corresponding operational instructions may be embedded within, or external to, the circuitry comprising the state machine, analog circuitry, digital circuitry, and/or logic circuitry.

As a general operational overview, the 3D graphics system 100 receives encoded video data 120 representing a real-time video stream from, for example, a file server or other video streaming service via the Internet or other type of network. The codec engine 102 operates to decode the encoded video data 120 to generate the video images comprising the real-time video stream. The graphics engine 104 operates to map this video stream onto a 3D object represented in an output stream 122 of display pictures. Each display picture of this output stream 122 is buffered in turn in a frame buffer 124, which in turn is accessed by the display controller 106 to control the display 108 to display the output stream 122 of display pictures at the display 108. The frame buffer 124 may be implemented in the memory 110 or in a separate memory. The 3D object is represented in each display picture as a corresponding geometric surface, with the geometric surface being formed as a set of polygons in a polygon mesh or wireframe. Each video image of the real-time video stream is thus mapped or projected onto the geometric surface representing the 3D object in the corresponding display picture

In a conventional system a decoded video image would be stored in its entirety in a memory outside of the IC package implementing the graphics engine before the graphics engine can begin mapping of the video image to the geometric surface in the corresponding display picture, and thus incur significant latency and memory bandwidth consumption as described above. In contrast, the 3D graphics system 100 implements a block-by-block video mapping process whereby the rendering of a display picture, including the mapping of a video frame to a geometric surface in the display picture, initiates while the decoding of the video frame is still progressing. In at least one embodiment, when decoding the video image the codec engine 102 generates a sequence 130 of decoded blocks of video (e.g., decoded blocks 132, 134, 136), and the concurrent decoding of the video image and mapping of the same video image into a display picture is achieved by treating each decoded block of the video image as it is generated in this sequence 130 as a separate texture that can be used by the graphics engine 104 for use in at least partially rendering, in a corresponding display picture (e.g., display picture 140), the polygons of the geometric surface to which that decoded block is mapped. This process is repeated for each decoded block as it is generated or otherwise output by the codec engine 102. Thus, rather than letting the scan order of the display picture control the rendering sequence for the geometric surface, the geometric surface is rendered in a sequence corresponding to the sequence 130 of decoded blocks of video output by the codec engine 102.

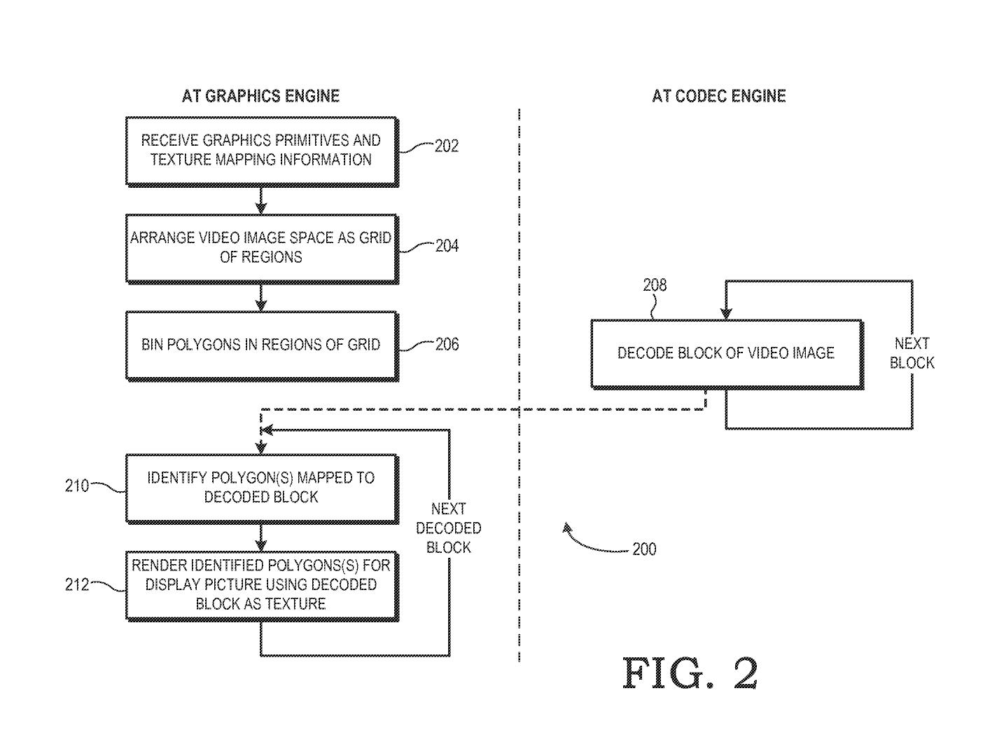

FIG. 2 illustrates a method 200 of performing the block-by-block video texture mapping process in the 3D graphics system 100 of FIG. 1 in accordance with at least one embodiment of the present disclosure. As noted above, the 3D graphics system 100 operates to project real-time video or another video stream (decoded from the encoded video data 120) onto a 3D object presented in the display pictures of the output stream 122. Thus, each video image, or frame, of the video stream is projected onto a geometric surface representing the 3D object in a corresponding display picture (or, depending on the input frame rate verses the output frame rate, in multiple display pictures). Method 200 illustrates this process for a single input video image mapped to a geometric surface of a single output display picture. Thus, the method 200 may be repeated for each input video image and output display picture in the stream.

The method 200 initiates at method block 202 with the receipt or determination of geometric surface information 150 (FIG. 1) and texture mapping information 152 (FIG. 1) at the graphics engine 104. The geometric surface information 150 represents the geometric surface of the 3D object that is to be displayed in the display picture, and thus can represent, for example, a perspective projection of a model of the 3D object as a wireframe or polygon mesh, and thus describes a set of polygons that represent the geometric surface. This info can be presented as, for example, a listing or other set of vertices of the polygons having coordinates (Xᵢ, Yᵢ) in the screen coordinate system (also called “screen space”) of the display picture. The texture mapping information 152 represents a mapping of the screen coordinates (Xᵢ, Yᵢ) of the polygons of the geometric surface to texture coordinates (Sᵢ, Tᵢ, Wᵢ) in the decoded video image as a texture space/texture map. That is, the texture mapping information 152 provides how the decoded video image is to be mapped as an overall texture to the polygons of the geometric surface. This texture mapping information can, include, for example, a list of triangles with screen coordinates and texture coordinates that correspond to the decoded block as a texture. Note again that a block in this context can refer to any logical grouping of decoded units output from a decoder as long as they are in the decode order of units. This block can mean a single macroblock or several macroblocks forming a tile or a slice, a series of rows, etc.

At method block 204, the graphics engine 104 segments the display space of the video image to be decoded into a grid of regions, whereby each region of the grid corresponds to a decoded block of the video image to be generated by the codec engine 102 during decoding of the video image. To illustrate, the codec engine 102 may decode the video image on a macroblock-by-macroblock basis, and thus each region may represent a location in the video image of a corresponding decoded macroblock. As another example, the codec engine 102 may decode the video image one row of macroblocks at a time. In this case, each region may represent a location in the video image of a corresponding row of decoded macroblocks. Other examples of decoded block/regions can include, for example, individual tiles of M×N macroblocks, partial or full rows of tiles, partial or full columns of tiles, and the like.

At method block 206, the graphics engine 104 uses the geometric surface information 150 and the texture mapping information 152 to bin the polygons of the geometric surface by region of the grid determined at method block 204. This binning process includes identifying, for each region of the grid, those polygons (if any) that intersect the region based on the texture coordinates of the polygons represented in the texture mapping information 152. From this binning process, the graphics engine 104 generates a bin listing or other data structure identifying, for each region, the polygons intersecting that region.

In parallel with the process of method blocks 202, 204, and 206, the codec engine 102 begins the process of decoding the encoded video data 120 to generate the video image. In this decoding process, through an iteration of method block 208, the codec engine 102 decodes the video image one block at a time, and thus generates the sequence 130 of decoded blocks of the video image. As each decoded block is generated by the codec engine 102, the codec engine 102 can temporarily cache the decoded block in the cache 112 on-chip with the graphics engine 104. This temporary caching can include, for example, storing one or a small subset of decoded blocks at any given time, and discarding the decoded block from the cache 112 soon after it is used by the graphics engine 104 for texture mapping as described below.

As each decoded block is generated by the codec engine 102 (at method block 208), the graphics engine 104 initiates the process of using the decoded block as a texture for the geometric surface of the 3D object to be rendered in the display picture. As noted above, each region of the grid of regions is mapped to a corresponding decoded block of the video image. Accordingly, at method block 210 the graphics engine 104 identifies the region of the grid that corresponds to the decoded block and then identifies which subset of polygons, if any, of the geometric surface intersect the region based on the bin list generated at method block 206. In the event that a subset of at least one polygon intersects the region corresponding to the decoded block, at method block 212 the graphics engine 104 uses the decoded block as a texture map to render, for each polygon of the subset, that portion of the polygon that intersects the region. Thus, any polygons fully contained within the region are completely rendered with the decoded block as the texture applied to the entire polygon. Any polygons that are only partially contained within the region are partially rendered using the decoded block as the texture applied to that intersecting region. Any of a variety of texture mapping processes may be utilized, such as linear interpolation, rational linear interpolation, antialiasing filtering, affine mapping, bilinear mapping, projective mapping, and the like. Moreover, additional rendering and mapping processes, such as bump mapping, specular mapping, lighting mapping, and the like, may be performed by the graphics engine 104 for the portions of the subset of polygons being rendered at method block 212. The resulting rendered pixels are stored in their corresponding locations in the frame buffer 124 in accordance with the display picture space, and the block is marked as consumed in view of completion of processing of the block.

While the graphics engine 104 is rendering the intersecting polygon portions for the grid region corresponding to one decoded block in accordance with one iteration of method blocks 210 and 212, the codec engine 102 is, in parallel, decodes another block of the video image at a next iteration of method block 208, and thus upon completion of the generation of the next decoded block, the rendering process of method blocks 210 and 212 may be repeated for this next decoded block. Iteration of the block decoding and rendering of polygons of the geometric space as each decoded block is generated thus continues until the decoding of the video image is completed. At this point, rendering of the display picture in the frame buffer 124 also is soon completed, and thus the display picture is available for display output to the display 108 via the display controller 106.

As the description of method 200 above illustrates, there is tight integration between the codec engine 102 in that as each decoded block is generated, it is quickly available to the graphics engine 104 for use as a texture for rendering at least a portion of the polygons of the geometric surface in the display picture being generated in the frame buffer 124. As decoding of the video image and rendering of the display picture progress in parallel, the display picture is completed much earlier, and thus is available for display much earlier, than conventional rendering systems that require completion of the decoding of the video image before beginning the process of mapping the video image to a geometric surface. Moreover, by temporarily caching the decoded blocks on-chip with the graphics engine 104, the graphics engine 104 is not required to access texture data from off-chip memory for rendering the geometric surface, and thus the block-by-block video mapping process of method 200 significantly reduces or eliminates considerable memory bandwidth consumption that otherwise would be required for the video texture mapping.

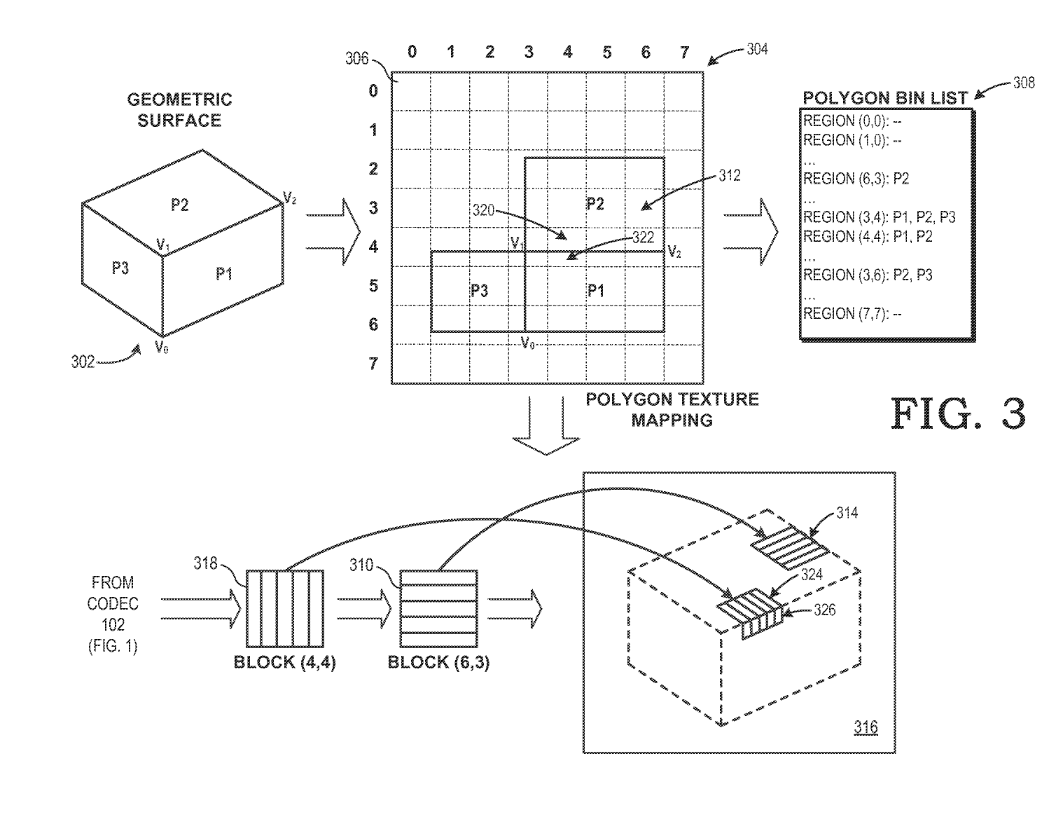

FIG. 3 illustrates an example application of the block-by-block video texture mapping process for the mapping of a video image to a geometric surface 302 representing, for example, a perspective view of a rectangular block. As illustrated, the geometric surface 302 is represented in the geometric surface information 150 (FIG. 1) as a set of three quadrilateral polygons (or “quads”), labeled P1, P2, and P3. Although FIG. 3 illustrates an example using a rectangular box as the 3D object and quadrilateral polygons for representing the geometric surface for ease of illustration, it will be appreciated that any of a variety of 3D objects may be implemented, including simpler objects such as spheres, columns, pyramids, cones, etc., as well as more complex objects, such as wireframe or polygon mesh models of buildings or other structures, animals, etc., and it will also be appreciated that any of a variety of polygon types may be implemented, including triangles, quads, and n-gons (n>3). Moreover, the video image may be projected to more than one geometric surface within the display picture. For example, the resulting display picture may include a mirror or other reflective surface that reflects the video image as presented in another object with the scene represented by the display picture. In such instances, the image content of the video image would be mapped to both a geometric surface representing the object and to a geometric surface representing the reflective surface reflecting the object.

The video image space is arranged into a grid 304 of regions 306, whereby each region 306 represents a location of a corresponding decoded block of the video image. In this example, the video image is to be decoded as a sequence of sixty-four tile-shaped blocks, and thus the grid 304 is arranged as an 8×8 array of regions 306, as depicted in FIG. 3. The texture mapping information 152 (FIG. 1) for this example maps the polygons P1, P2, and P3 to the video image space as a texture map as shown in the texture mapping of FIG. 3. For example, vertex V₀ (present in polygons P1 and P3) is represented in the display screen space as coordinates (X₀, Y₀) and mapped to the video image grid as texture coordinate (S₀, T₀, W₀) (Wᵢ being the depth of vertex i), vertex V₁ (present in polygons P1, P2, and P3) is represented in the display screen space as coordinates (X₁, Y₁) and mapped to the video image grid as texture coordinate (S₁, T₁, W₁), vertex V₂ (present in polygons P1 and P2) is represented in the display screen space as coordinates (X₂, Y₂) and mapped to the video image grid as texture coordinate (S₂, T₂, W₂).

From this texture mapping, the graphics engine 104 bins the polygons P1, P2, P3 by region of the grid 304, thus generating the illustrated polygon bin list 308. To illustrate, as depicted by the polygon bin list 308, region (6,3) is intersected by polygon P2, region (3,4) is intersected by all three polygons P1, P2, P3, and so forth. As noted by the polygon bin list 308, in some instances one or more regions 306 of the grid 304 do not intersect any of the polygons of the geometric surface 302, and thus the corresponding decoded block is not used as a texture for mapping to the geometric surface 302.

With the polygon bin list 308 generated, the graphics engine 104 can begin mapping decoded blocks of the video image to the geometric surface 302 as they are output by the codec engine 102 (and cached in the cache 112 for ease of access by the graphics engine 104). Thus, when a decoded block 310 is output by the codec engine 102 to the cache 112, the graphics engine 104 can access the decoded block 310 from the cache 112, determine its corresponding region of the grid 304 (region (6,3) in this example), and from the polygon bin list 308 identify polygon P2 as intersecting the corresponding region (6,3) and thus using the decoded block 310 as a texture. Accordingly, the graphics engine 104 uses the image content of the decoded block 310 to map the image content to the corresponding portion 312 of the polygon P2 that intersects region (6,3) as a corresponding texture-mapped region 314 in a display picture 316. For ease of illustration, the image content of the decoded block 310 comprises a simple set of horizontal lines, which are mapped as a perspective projection region of the polygon P2 in the display picture 316. After the graphics engine 104 has rendered the region 314 of the polygon P2 in the display picture 316 using the decoded block 310 as texture, the decoded block 310 can be discarded from the cache 112. It will be appreciated that the cache 112 can be slightly bigger than the size of a decoded block, or it can accumulate two or more decoded blocks.

Similarly, when a decoded block 318 is output by the codec engine 102 to the cache 112, the graphics engine 104 can access the decoded block 318 from the cache 112, determine its corresponding region of the grid 304 (region (4,4) in this example), and from the polygon bin list 308 identifies polygons P1 and P2 as intersecting the region (4,4) corresponding to the decoded block 318. The graphics engine 104 thus uses the image content of the decoded block 318 to map the image content to the corresponding portions 320 and 322 of the polygons P1 and P2, respectively, that intersect region (4,4) as corresponding texture-mapped regions 324 and 326, respectively, in the display picture 316. For ease of illustration, the image content of the decoded block 318 comprises a simple set of vertical lines, which are mapped as perspective projection regions of the polygons P1 and P2 in the display picture 316. After the graphics engine 104 has rendered the regions 324 and 326 of the polygons P1 and P2 in the display picture 316 using the decoded block 318 as texture, the decoded block 318 can be discarded from the cache 112.

The process described above can be repeated for each decoded block generated by the codec engine 102 for the video image, and thus upon processing of the final decoded block of the decode output sequence, the mapping of the video image to the geometric surface 302 completes, and the display picture 316 is ready to be accessed from the frame buffer 124 for display output.

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

In this document, relational terms such as “first” and “second”, and the like, may be used solely to distinguish one entity or action from another entity or action without necessarily requiring or implying any actual relationship or order between such entities or actions or any actual relationship or order between such entities and claimed elements. The term “another”, as used herein, is defined as at least a second or more. The terms “including”, “having”, or any variation thereof, as used herein, are defined as comprising.

Other embodiments, uses, and advantages of the disclosure will be apparent to those skilled in the art from consideration of the specification and practice of the disclosure disclosed herein. The specification and drawings should be considered as examples only, and the scope of the disclosure is accordingly intended to be limited only by the following claims and equivalents thereof.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A three-dimensional (3D) graphics system comprising:
a codec engine to decode encoded video data to generate a sequence of decoded blocks of a video image; and
a graphics engine to render a geometric surface of a 3D object in a display picture by rendering polygons of the geometric surface using each decoded block in the sequence as a texture map for a corresponding subset of the polygons concurrent with the codec engine generating the next decoded block in the sequence.

2. The 3D graphics system of claim 1, wherein the graphics engine is to render the geometric surface in the display picture by:
mapping of the polygons of the geometric surface to a grid of regions representing the video image, each region of the grid corresponding to a decoded block of the video image; and
as each decoded block of the video image is generated in the sequence:
identifying a corresponding subset of polygons of the geometric surface that intersect a region of the grid corresponding to the decoded block based on the mapping; and
for each polygon of the subset, rendering in the display picture that portion of the polygon that intersects the region of the grid in the mapping using the decoded block as a texture map.

3. The 3D graphics system of claim 2, wherein:
the graphics engine is to bin the polygons of the geometric surface based on the mapping to generate a listing of polygons for each region of the grid; and
the graphics engine is to identify the corresponding subset of polygons based on the listing.

4. The 3D graphics system of claim 1, further comprising:
an integrated circuit (IC) package comprising:
the codec engine;
the graphics engine; and
a cache coupled to an output of the codec engine and to an input of the graphics engine, the cache to cache a subset of the decoded blocks for use by the graphics engine.

5. The 3D graphics system of claim 4, wherein the graphics engine is to render the geometric surface in the display picture without accessing texture information from memory outside the IC package.

6. The 3D graphics system of claim 1, wherein the encoded video data comprises a real-time video stream.

7. A method for texture mapping a video image to a geometric surface of a three-dimensional (3D) object in a display picture, the method comprising:
decoding encoded video data to generate a sequence of decoded blocks of the video image; and
rendering the geometric surface in the display picture by rendering polygons of the geometric surface using each decoded block in the sequence as a texture map for a corresponding subset of the polygons concurrent with generating the next decoded block in the sequence.

8. The method of claim 7, wherein rendering the 3D object in the display picture comprises:
determining a mapping of polygons of the geometric surface to a grid of regions representing the video image, wherein each region of the grid corresponds to a decoded block of the video image; and
as each decoded block of the video image is generated in the sequence:
identifying a corresponding subset of the polygons of the geometric surface that intersect the region of the grid corresponding to the decoded block based on the mapping; and
for each polygon of the subset, rendering in the display picture that portion of the polygon that intersects the region of the grid in the mapping using the decoded block as a texture map.

9. The method of claim 8, wherein the rendering in the display picture that portion of the polygon that intersects a region of the grid corresponding to a first decoded block of the video image is performed concurrently with decoding of the encoded video data to generate a second decoded block of the video image.

10. The method of claim 8, wherein the regions of the grid comprise at least one of: tiles of the video image, rows of tiles of the video image; and columns of tiles of the video image.

11. The method of claim 7, wherein:
decoding encoded video data comprises decoding encoded video data using a codec engine of an integrated circuit (IC) package; and
rendering the geometric surface comprises rendering the geometric surface using a graphics engine of the IC package; and
marking the decoded video data as consumed after the graphics engine has processed the block.

12. The method of claim 11, further comprising:
caching, by the codec engine, each decoded block of the video image in a cache of the IC package after generating the decoded block; and
accessing, by the graphics engine, each decoded block from the cache prior to rendering using the decoding block; and
marking the decoded video data as consumed after the graphics engine has processed the block.

13. The method of claim 11, wherein caching each block results in the discard of a previous decoded block or blocks from the cache after graphics engine has used the decoded block as the texture map for rendering the corresponding subset of polygons.

14. The method of claim 11, wherein rendering the geometric surface in the display picture comprises rendering the geometric surface without the graphics engine accessing texture information from memory outside the IC package.

15. The method of claim 7, wherein the video image is a frame of a real-time video stream.

16. A non-transitory computer readable storage medium storing a set of executable instructions, the set of executable instructions to manipulate at least one processor to:
decode encoded video data to generate a sequence of decoded blocks of the video image; and
render a geometric surface representing a 3D object in a display picture by rendering polygons of the geometric surface using each decoded block in the sequence as a texture map for a corresponding subset of the polygons concurrent with the generation of the next decoded block in the sequence.

17. The non-transitory computer readable storage medium of claim 16, wherein the executable instructions to manipulate at least one processor to render the geometric surface in the display picture comprise executable instructions to manipulate at least one processor to:
determine a mapping of polygons of the geometric surface to a grid of regions representing the video image, wherein each region of the grid corresponds to a decoded block of the video image; and
as each decoded block of the video image is generated in the sequence:
identify a corresponding subset of the polygons of the 3D object that intersect the region of the grid corresponding to the decoded block based on the mapping; and
for each polygon of the subset, render in the display picture that portion of the polygon that intersects the region of the grid in the mapping using the decoded block as a texture map.

18. The non-transitory computer readable storage medium of claim 17, wherein the regions of the grid comprise at least one of: tiles of the video image, rows of tiles of the video image; and columns of tiles of the video image.

19. The non-transitory computer readable storage medium of claim 16, wherein the set of executable instructions further comprises executable instructions to manipulate at least one processor to cache each decoded block of the video image in an on-chip cache after generating the decoded block.

20. The non-transitory computer readable storage medium of claim 16, wherein the video image is a frame of a real-time video stream.
